(19) United States
(12) Patent Application Publication
(10) Pub. No.: US 2013/0134938 A1
(43) Pub. Date: May 30, 2013

(54) Onboard EVSE System for Electric Vehicle

(71) Applicant: James S. Bianco, Suffield, CT (US)

(72) Inventor: James S. Bianco, Suffield, CT (US)

(21) Appl. No.: 13/688,409

(22) Filed: Nov. 29, 2012

Related U.S. Application Data
(60) Provisional application No. 61/564,583, filed on Nov. 29, 2011.

(51) Int. Cl. H02J 7/00

(52) U.S. Cl. CPC H02J 7/00
USPC 320/109; 320/137

(57) ABSTRACT

An electric utility vehicle comprises an onboard EVSE, a battery charger and a battery power supply. The onboard EVSE may be connected to an electric outlet adjacent a loading dock. The onboard EVSE then connects to the battery charger for charging the battery power supply. A selector module is employed to connect either the onboard EVSE to the battery charger or to connect with an alternate power line.

### CROSS-REFERENCE TO RELATED APPLICATION

This application claims the priority of U.S. Provisional Patent Application No. 61/564,583 filed on Nov. 29, 2011, the disclosure of which is incorporated by reference in its entirety.

### BACKGROUND

This disclosure relates generally to devices and methods for charging the battery power supply of an electric vehicle. More particularly, this disclosure relates to methods and devices for charging electric vehicles, which make numerous stops for loading and unloading.

Trucks and utility vehicles which employ a battery power supply to provide the principal motive drive are becoming more and more numerous. The versatility, effectiveness and usage of such vehicles is subject to the limited effective battery charge. Optimum usage and efficiency of electric vehicles is a function of the capability of the vehicle to make numerous stops for the loading and unloading of cargo while being able to fully operate on a battery power charge.

Typically, the electric vehicle is charged at the home base; however, there are few publicly available outlets at electric vehicle service equipment (“EVSE”) facilities for charging electric vehicles away from the home base or charging station. It would be expensive to provide EVSE at each loading/unloading site.

### SUMMARY

Briefly stated, an onboard EVSE system for an electric vehicle comprises a battery power supply and a battery charger which charges the batter power supply. A selector module controls the source of power to the battery charger. A first power inlet connects with the selector module. An onboard EVSE connects with a second power inlet and the selector module. The selector module selectively directs power to the battery charger to charge the batter power supply when power is supplied to the first or the second power inlet.

A breaker is interposed between the second power inlet and the onboard EVSE. The onboard EVSE first power inlet is a J1772 inlet. The second power inlet is a 220 VAC inlet.

The onboard EVSE has a second proximity signal line and a second pilot signal line which communicate with the selector module. The selector module has a first inlet proximity signal line and a first inlet pilot signal line communicating from the first power inlet to the selector module.

An output proximity signal line and an output pilot signal line communicate between the selector module and the battery charger. A relay selectively connects the first proximity and the first pilot signal lines and the second proximity and the second pilot signal lines to the corresponding pilot and proximity output lines communicating with the onboard battery charger.

The selector module further comprises a relay which selectively connects power applied at the first or the second power inlet to the battery charger. The onboard EVSE senses power and comprises a controller which generates a power control signal and a communication control signal to the selector module.

An electric vehicle comprises a battery power supply and a battery charger which charges the battery power supply. A selector module controls signal communication and the source of power to the battery charger. A power inlet is mounted to the vehicle and connects a first power line with the selector module. A second power line is mounted to the vehicle.

An onboard EVSE is carried by the vehicle and communicates with the second power line and the selector module. The selector module selectively directs power to the battery charger to charge the battery power supply in accordance with the supply of power to the first or the second power line. A breaker is interposed in the second power line. The second power line connects with an exteriorly accessible 220 VAC inlet.

The onboard EVSE has a second proximity signal line and a second pilot signal line which communicates with the selector module. The selector module has a first inlet proximity signal line and a first inlet pilot signal line communicating from the first power inlet. An output proximity signal line and an output signal pilot line communicate between the selector module and the battery charger. A relay selectively connects the first proximity signal and the first pilot signal lines or second proximity signal and pilot signal lines to corresponding pilot and proximity output lines communicating with the onboard battery charger. The selector module further comprises a relay which selectively connects power from the first or the second power line to the battery charger.

A method for charging an electric utility vehicle comprises providing an onboard EVSE, battery charger and battery power supply. An electric outlet is installed adjacent a loading dock. The electric utility vehicle is parked at the loading dock. The onboard EVSE is connected to the electric outlet. The onboard EVSE is connected to the battery charger and the onboard EVSE charges the battery power supply.

### BRIEF DESCRIPTION OF THE DRAWINGS

FIG. 1 is a schematic view of a delivery vehicle parked at a loading dock and connected for charging the vehicle battery supply employing an onboard EVSE system;

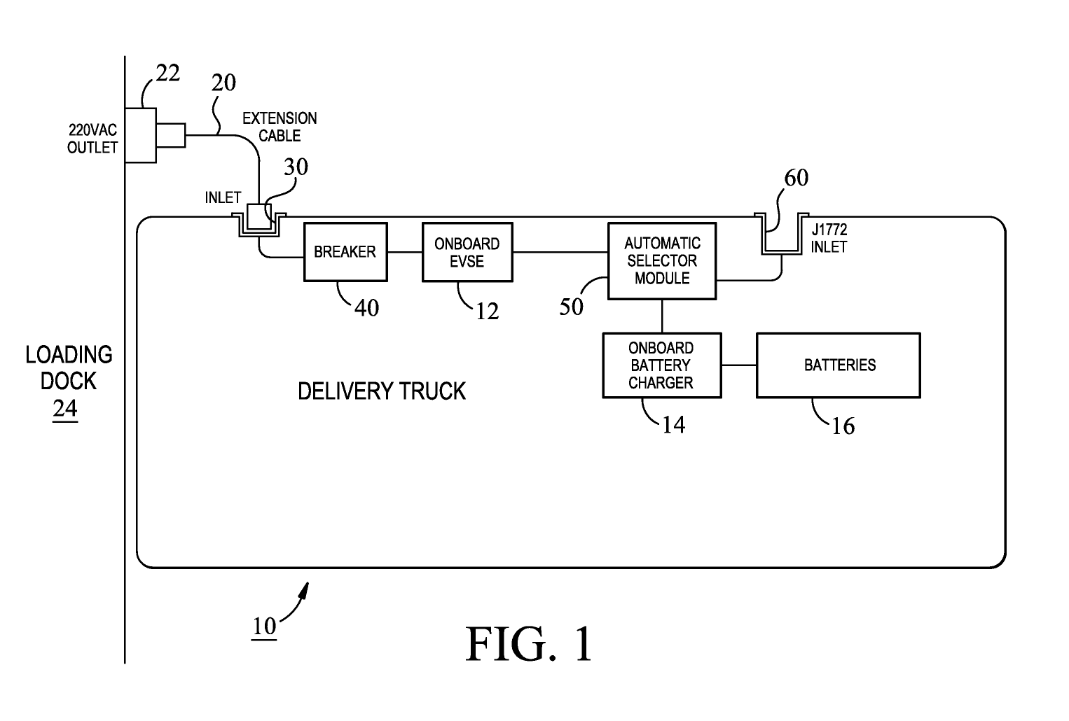

FIG. 2 is a schematic block diagram illustrating the onboard EVSE system as incorporated into a delivery truck; and

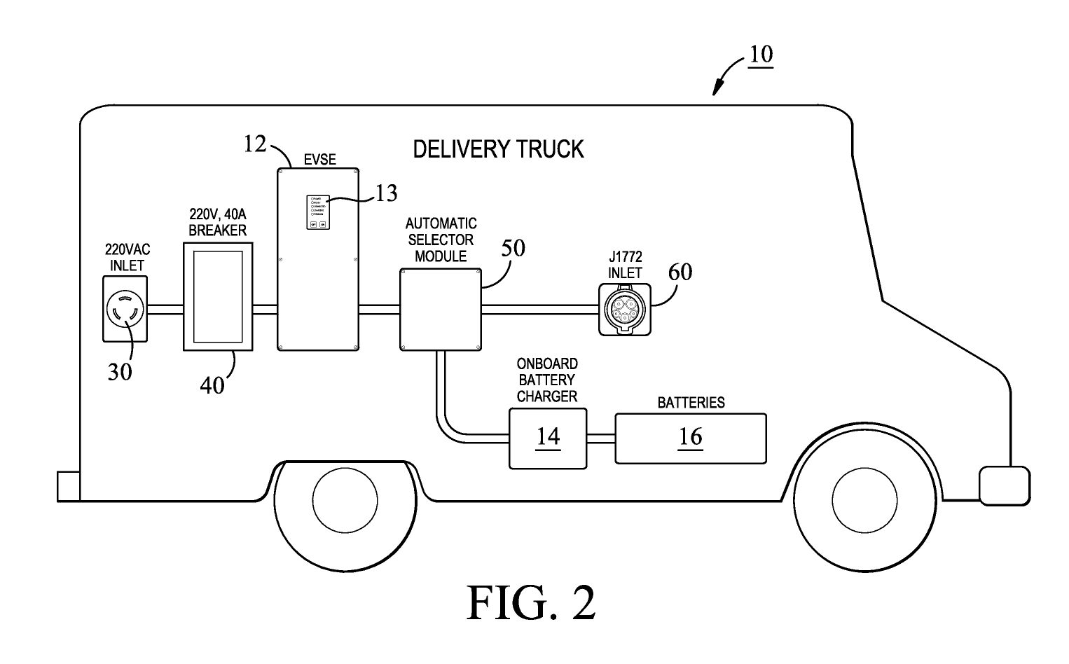

FIG. 3 is a schematic diagram illustrating the operation of an onboard EVSE system.

### DETAILED DESCRIPTION

With reference to the drawings wherein like numerals represent like parts throughout the Figures, an onboard EVSE system is preferably implemented in connection with an electric vehicle which transports cargo, such as a delivery truck designated generally by the numeral 10. The onboard EVSE system would have application also in connection with any electric vehicle. The onboard EVSE system is adapted to provide a supplemental power charge at locations remote from the home charging station for the electric vehicle.

An onboard EVSE 12 is adapted to receive electric power from either a 110, 220 or 440 VAC line of conventional form and function. The onboard EVSE 12 is modified over conventional EVSE but otherwise functions in a manner similar to most EVSE to supply power as well as various signaling functions to the onboard battery charger 14 which is conventionally employed in the electric vehicle. The charger 14 then charges the battery power supply 16 of the electric vehicle without requiring the installation of EVSE at the loading/unloading sites.

The preferred mode of remote operation is that an extension cable 20 is provided to connect with a conventional 110, 220 or 440 VAC outlet 22 in the vicinity of a loading dock 24. For most applications, outlet 22 is a 220 VAC outlet. An outlet is provided at each or several of the loading docks which the delivery truck visits. Each outlet essentially replaces, in a less expensive manner, an EVSE installation at each location. When the delivery truck is parked in the vicinity of the loading dock 24, the extension cable 20 extends from a power inlet 30 at the vehicle exterior and connects with the outlet 22. Alternatively, the extension cable is permanently electrically connected and automatically coiled and stored within the vehicle and does not require connection to the power inlet 30. Naturally, the onboard battery charger 14 is also capable of receiving power from an EVSE (not illustrated) located at a fixed location, or otherwise exteriorly disposed of the vehicle for charging the battery power supply.

The power inlet 30 connects via a breaker 40 and power lines 32 and 34 with the onboard EVSE 12. The breaker may have a 40 amp or other suitable rating. The onboard EVSE 12 preferably has an operator and status indicator panel 13. The onboard EVSE 12 also connects with an automatic selector module 50. For most electric vehicles which have a J1772 inlet connector for the battery charger 14, the automatic selector module 50 selectively controls the source of the supply of power to the onboard battery charger 14 which charges the battery supply 16 of the delivery truck.

The delivery truck 10 typically also has an exteriorly accessible J1772 inlet 60 which connects with a conventional J1772 connector of a cable for a fixed EVSE station (not illustrated). The power inlet 60 connects via power lines 62 and 64 and communicates via a proximity signal line 66 and a pilot power line 68 with the automatic selector module 50.

The onboard EVSE system enhances the opportunity for the electric vehicle to receive supplemental battery charges during the working day without returning to the base EVSE charging station and without requiring numerous EVSE installations at various stops. The initial power charge is supplied in a conventional manner at the site where the electric vehicle is typically parked overnight and/or during non-usage periods. When the vehicle is unloading and loading at various loading docks, the operator can immediately plug in the extension cable 20 at the 220 VAC outlet 22 at the loading dock 24 and charge the vehicle via the EVSE 12 while the vehicle is parked. Consequently, one or more additional battery charges can be supplied during the workday to supplement the initial battery power charge and to extend the effective transit and useful working time for the electric vehicle.

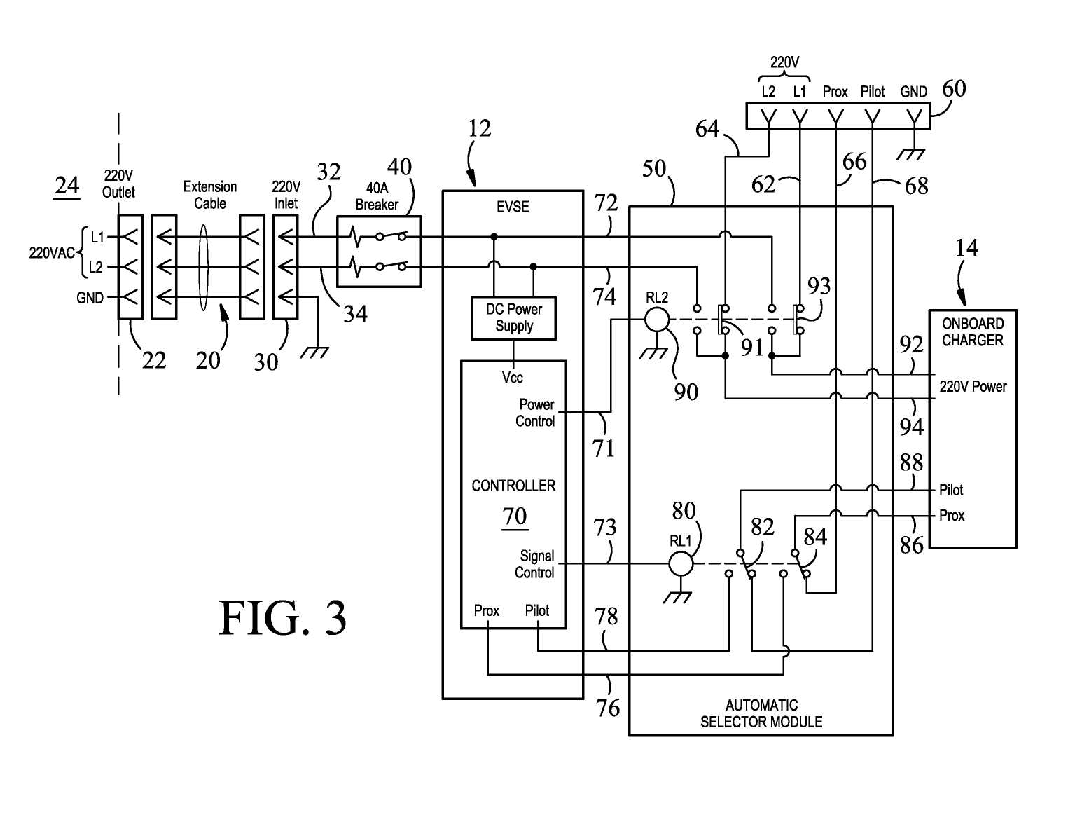

With reference to FIG. 3, the selector module 50 controls the source of the supply of power and the various signal lines to the onboard charger 14 in accordance with whether power is exteriorly supplied by EVSE located exteriorly of the electric vehicle or power is supplied to the onboard EVSE. The onboard EVSE 12 in many respects has a conventional form and function but also includes a power control line 71 and a signal control line 73 responsive to the onboard EVSE controller 70. The onboard EVSE power lines 72 and 74 connect with the selector module 50. A proximity line 76 and a pilot line 78 transmit proximity and pilot signals from the EVSE controller 70 to the selector module 50.

Power is supplied to the onboard EVSE through the outlet 22 at or adjacent the loading dock. An extension cable connects the outlet with the inlet 30 which is exteriorly accessible at the side of the utility vehicle or directly communicates with the EVSE 12 as further described below. The input power passes through a 40 amp (or other rated) breaker to connect with the onboard EVSE 12.

The selector module 50 connects input power lines 62 and 64 which receive power from the conventional inlet connector 60 exteriorly accessible at the side of the utility vehicle. Inlet connector 60 is preferably a J1772 inlet connector. The inlet connector also connects with a proximity signal line 66 and a pilot signal line 68 to the selector module.

The signal control line 73 from the onboard EVSE controller 70 controls a first relay 80 of the selector module. The relay 80 controls tandem bi-stable switches 82 and 84 which connect in one of two signal modes. In a first signal mode when power is supplied to and sensed by the onboard EVSE 12, the proximity signal line 76 and the pilot signal line 78 from the onboard EVSE connect to the corresponding output proximity signal line 86 and pilot signal line 88 from the selector module which communicates with the onboard charger 14.

After communication is established over the pilot signal line between the onboard EVSE 12 and the charger 14, the power control line 71 from the EVSE controller 70 operates a second relay 90. The second relay 90 operates to connect power from the EVSE 12 to the charger 14. The power lines 72 and 74 from the onboard EVSE in tandem connect at contacts 91 and 93 to the output power lines 92 and 94 which communicate from the selector module to the onboard charger 14.

In the second signal mode when power is supplied at the J1772 connector 60, the proximity signal line 66 and the pilot signal lines 68 from the J1772 inlet connector connect to the corresponding output proximity signal line 86 and the output pilot signal line 88 which communicate with the onboard charger 14. Likewise, when power is applied to the J1772 inlet connector, the power lines 62 and 64 from the J1772 inlet 60 connect via relay 90 in tandem to the output power lines 92 and 94 to the onboard charger 14.

The selector module 50 is not required if the electric vehicle does not have a J1772 inlet connector or the J1772 inlet connector is not used, but the vehicle is entirely charged through the onboard EVSE 12. The EVSE 12 would thus communicate and connect directly with the charger 14.

It will be appreciated that when power is supplied from the outlet 22 at the loading dock to the inlet 30, then the selector module 50 connects the onboard EVSE 12 with the onboard charger 14 to provide the appropriate communication and power line interface. When the power is supplied to the J1772 connector inlet 60 (from an exterior EVSE), the selector module 50 functions to connect the power with the onboard charger 14, as well as initially connect the proximity and pilot signal lines.

When power is supplied from the dock to inlet 30, the power supply has priority over power through the J1772 connector inlet 60, and the onboard EVSE 12 operates on the power supplied from the dock. In addition, the EVSE 12 prevents the vehicles from starting until the power extension cable 20 is unplugged.

1. An onboard EVSE system for an electric vehicle comprising:
a battery power supply;
a battery charger which charges said battery power supply;
a selector module controlling the source of power to said battery charger;
a first power inlet connecting with said selector module;
a second power inlet; and
an onboard EVSE connecting with said second power inlet and said selector module,
wherein said selector module selectively directs power to said battery charger to charge said battery power supply when power is supplied to said first power inlet or said second power inlet.

2. The onboard EVSE system of claim 1, comprising a breaker interposed between said second power inlet and said onboard EVSE.

3. The onboard EVSE system of claim 1, wherein said first power inlet is a J1772 inlet.

4. The EVSE system of claim 1, wherein the said second power inlet is a 220 VAC inlet.

5. The onboard EVSE system of claim 6, wherein said EVSE has a second proximity signal line and a second pilot signal line which communicate with said selector module.

6. The onboard EVSE system of claim 5, wherein said selector module has a first inlet proximity signal line and a first inlet pilot signal line communicating from said first power inlet to said selector module.

7. The onboard EVSE system of claim 6, further comprising an output proximity signal line and an output pilot signal line communicating between said selector module and said battery charger, and a relay which selectively connects said first proximity and first pilot signal lines and said second proximity and second pilot signal lines to corresponding pilot and proximity output lines communicating with said onboard battery charger.

8. The onboard EVSE system of claim 1, wherein said selector module further comprises a relay which selectively connects power applied at said first power inlet or said second power inlet to the battery charger.

9. The onboard EVSE system of claim 1, wherein said onboard EVSE senses power and comprises a controller which generates a power control signal and a communication control signal to said selector module.

10. An electric vehicle comprising:
a battery power supply;
a battery charger which charges said battery power supply;
a selector module controlling signal communication and the source of power to said battery charger;
a power inlet mounted to said vehicle and connecting a first power line with said selector module;
a second power line mounted to said vehicle; and
an onboard EVSE carried by said vehicle communicating with said second power line and said selector module,
wherein said selector module selectively directs power to said battery charger to charge said battery power supply in accordance with the supply of power to said first power line or said second power line.

11. The electric vehicle of claim 10, comprising a breaker interposed in said second power line.

12. The electric vehicle of claim 10, wherein the said second power line connects with an exteriorly accessible 220 VAC inlet.

13. The electric vehicle of claim 12, wherein said onboard EVSE has a second proximity signal line and a second pilot signal line which communicate with said selector module.

14. The electric vehicle of claim 13, wherein said selector module has a first inlet proximity signal line and a first inlet pilot signal line communicating from said first power inlet.

15. The electric vehicle of claim 14, further comprising an output proximity signal line and an output signal pilot line communicating between said selector module and said battery charger, and a relay which selectively connects said first proximity signal and first pilot signal lines or said second proximity signal and pilot signal lines to corresponding pilot and proximity output lines communicating with said onboard battery charger.

16. The electric vehicle of claim 10, wherein said selector module further comprises a relay which selectively connects power from said first power line or said second power line to the battery charger.

17. A method of charging an electric utility vehicle comprising:
providing an onboard EVSE, battery charger and battery power supply;
parking said electric utility vehicle at a loading dock;
accessing an electric outlet adjacent said loading dock;
connecting said onboard EVSE to said electric outlet;
connecting said onboard EVSE to said battery charger; and
using said onboard EVSE to charge said battery power supply.

18. The method of claim 17 further comprising connecting said battery charger with an inlet which connects with a EVSE located remotely from said vehicle and charging said battery power supply.

19. The method of claim 18 further comprising selectively controlling the supply of power to said battery charger through said onboard EVSE or remote EVSE.

20. The method of claim 19 wherein the step of selectively controlling the supply of power is performed automatically.
